(19) United States
(12) Patent Application Publication
(10) Pub. No.: US 2026/0362574 A1
(43) Pub. Date: Nov. 12, 2026

(54) LIGHT SWITCH

(71) Applicant: TEWKE LIMITED, London (GB)

(72) Inventors: Rowan DIXON, London (GB); Lyudmil ATANASOV, London (GB)

(21) Appl. No.: 19/135,050

(22) PCT Filed: Dec. 1, 2023
(86) PCT No.: PCT/GB2023/053109

§ 371 Date: Jun. 2, 2025

(30) Foreign Application Priority Data
Dec. 2, 2022 (GB) 2218185.3

(51) Int. Cl. H05B 47/175; G06F 3/01; H02J 9/06; H05B 47/115; H05B 47/155; H05B 47/17; H05B 47/19

(52) U.S. Cl. CPC H05B 47/196; G06F 3/011; G06F 3/016; H02J 9/061; H05B 47/115; H05B 47/155; H05B 47/17; H05B 47/19

(57) ABSTRACT

A smart light switch comprising a screen module, a wall module and, optionally, a mount. The screen module comprising a display, an input device, an energy storage device, a screen module controller and a first screen module connector configured to be operably connected with a wall module, wherein the connector is configured to supply electrical power to the screen module from the wall module. The wall module comprising a wall module controller, a first wall module connector configured to be operably connected to a screen module, wherein the connector is configured to supply electrical power to the screen module from the wall module, and a first electrical connector configured to be operably connected to the electrical wiring of a lighting circuit.

### BACKGROUND

Lighting circuits in properties may have either two or three wires. In almost all older buildings, and even in many newly built properties, the lighting circuits will only have two wires. A light switch in a three-wire lighting circuit has a live wire, a neutral wire and wire that continues from the light switch to the rest of the lighting circuit. When the lighting circuit is switched on, the continuing wire carries the live current to the light fittings in the circuit. This wire is commonly referred to as the “switch live” wire. A two-wire circuit does not have a neutral wire, and so a light switch in a two-wire circuit is connected only to the live wire and the switch live wire. This means that in a three-wire circuit, a light switch is able to draw current from the lighting circuit when the lights are in the off state using only the live and the neutral wire (i.e., without any current passing through the switch live wire). In a two-wire circuit, however, the only way for a light switch to draw current from the lighting circuit is by passing that current through the switch live wire, which means it is also drawn through any light fittings that are connected to the circuit.

A typical lighting circuit comprises one or more light fittings and one or more light switches. A light fitting is a device that is connected to the lighting circuit and is configured to provide electrical power to a light bulb. Many types of light bulbs exist, some common types are: incandescent, fluorescent, halogen, LED (light emitting diode). A light switch is a device configured to interrupt power to the lighting circuit, thereby to switch the lights between an on and an off state. A standard mechanical switch simply switches between completing the lighting circuit (on) and interrupting the lighting circuit (off). Dimmer switches may also be used, which allow for the amount of illumination provided by the lights to be varied across a range between simply “on” and “off”. Specialised dimmer switches may be needed in order to be able to vary the amount of illumination provided by certain types of bulbs (for example, LED bulbs).

Smart light switches are devices that allow for additional functionality above and beyond the switching function of a standard mechanical or dimmer light switch. A typical smart light switch must be provided with power at all times in order to provide the smart switch functionality.

In a two-wire lighting circuit, the light switches and light fittings are wired into a single continuous circuit. When a two-wire lighting circuit is switched on, electrical power flows through all of the light fittings and switches in the circuit, thereby causing the light fittings to provide illumination. Similarly, when the light circuit is switched off, no electrical power flows through the circuit.

Smart switches typically cannot be used with two-wire lighting circuits, because electrical power is needed by the smart switch at all times in order to function. In order to provide a constant power supply to the smart switch, a two-wire lighting circuit cannot be interrupted. This means that a smart-switch installed in a two-wire lighting circuit must draw enough power to operate from the lighting circuit, even when the lights are switched to an “off state” (i.e., a state where they do not produce visible illumination).

In a two-wire lighting circuit, any electrical power drawn by the smart switch must also pass through the rest of the two-wire lighting circuit. Light bulbs generally do not require much electrical power in order to provide visible illumination (although more may be needed in order to provide the required illumination when the lighting circuit is switched on). This means that in a two-wire circuit, if the smart switch were to draw more than a very small amount of electrical power the lights connected to the circuit would produce visible illumination. This is clearly an unacceptable situation for most consumers.

Existing solutions to this problem generally involve providing a smart switch with very basic functionality that requires only a very small amount of power to operate. This allows the smart switch to maintain functionality when the lighting circuit is switched to an “off state”, by drawing a sufficiently small amount of power from the lighting circuit to prevent visible illumination of the lights. A further existing solution is to provide a smart switch that varies its functionality based on whether the lighting circuit is switched to an on state or an off state. For example, a switch may provide more advanced functionality when the lighting circuit is in an on state, as it is able to draw more power from the lighting circuit, but provides only limited functionality when the lighting circuit is switched to an off state, as it can only draw a very small amount of power from the lighting circuit.

There exists, therefore, a need to provide a smart light switch for use in a two-wire lighting circuit that is able to provide advanced functionality when the lighting circuit is in either an on state or an off state.

### SUMMARY OF INVENTION

Aspects and embodiments of the disclosure provide a device for controlling a lighting circuit, as claimed in the appended claims.

According to one aspect, there is provided a screen module for use in a smart light switch, the screen module comprising: a display; an input device; an energy storage device; a screen module controller; and a first screen module connector configured to be operably connected with a wall module, wherein the connector is configured to supply electrical power to the screen module from the wall module; wherein the screen module controller is operable to: determine the charge state of the energy storage device; and if electrical power is supplied to the first screen module connector and the determined charge state of the energy storage device indicates that the energy storage device is not fully charged, configure the screen module to use at least a portion of the supplied electrical power to charge to the energy storage device; and wherein the screen module controller is further operable to: determine if the limit of the amount of electrical power being supplied to the screen module via the first screen module connector is at or above a threshold amount; if the limit is determined to be at or above the threshold amount, configure the screen module to be powered by the electrical power supplied via the first screen module connector; and if the limit is determined to be below the threshold amount, configure the screen module to be powered by the energy storage device.

In an embodiment, there is provided a screen module wherein the input device is a touch screen.

In another embodiment, there is provided a screen module further comprising a haptic motor configured to give haptic feedback.

In another embodiment, there is provided a screen module further comprising at least one sensor selected from a group comprising: an air quality sensor, a temperature sensor, an infrared camera, a visible spectrum camera, a microphone.

In another embodiment, there is provided a screen module further comprising a privacy switch configured to selectively disable one or more of the sensors.

In another embodiment, there is provided a screen module further comprising a speaker.

In another embodiment, there is provided a screen module further comprising a wireless communication controller configured to provide the screen module with wireless communication capability.

In another embodiment, there is provided a screen module further comprising a second screen module connector configured to be operably connected with a mount.

According to another aspect, there is provided a wall module for use in a smart light switch, the wall module comprising: a wall module controller; a first wall module connector configured to be operably connected to a screen module, wherein the connector is configured to supply electrical power to the screen module from the wall module; and a first electrical connector configured to be operably connected to the electrical wiring of a lighting circuit; wherein the wall module controller is operable to: determine if a connected lighting circuit is in an on state or an off state; if the connected lighting circuit is determined to be in an off state, configure the wall module to limit the supply electrical power to the first wall module connector to below a threshold amount; and if the connected lighting circuit is determined to be in an on state, configure the wall module to allow for the supply electrical power to the first wall module connector to equal or exceed the threshold amount.

In an embodiment, there is provided a wall module wherein the threshold amount is the maximum amount of electrical power that can be drawn from a connected lighting circuit, without causing any lights of the connected lighting circuit to produce visible light.

In another embodiment, there is provided a wall module wherein the wall module controller is further configured such that, when connected to a lighting circuit, the wall module controller is able to determine the threshold amount.

In another embodiment, there is provided a wall module further comprising at least one switch configured to allow a user to change the on/off state of a connected lighting circuit.

In another embodiment, there is provided a wall module further comprising at least one additional electrical connector.

In another embodiment, there is provided a wall module wherein each of the at least one additional connectors are configured to be operably connected to a separate lighting circuit.

In another embodiment, there is provided a wall module further comprising a second wall module connector configured to be operably connected to a mount.

In another embodiment, there is provided a wall module further comprising a wireless communication controller configured to provide the wall module with wireless communication capability.

According to another aspect, there is provided a smart light switch comprising a screen module and a wall module.

In an embodiment, there is provided a smart light switch further comprising a mount.

In another embodiment, there is provided a smart light switch wherein the mount is operably connected to at least one of the screen module and the wall module.

In another embodiment, there is provided a smart light switch wherein the mount further comprises at least one of: a speaker, a display, an air quality sensor, a temperature sensor, an infrared camera, a visible spectrum camera, a microphone, a wireless communication controller configured to provide the mount with wireless communication capability, an energy storage device, an input device.

### BRIEF DESCRIPTION OF THE DRAWINGS

One or more embodiments of the present disclosure will now be described by way of example only, with reference to the accompanying drawings, in which:

FIG. 1 shows an embodiment of a smart light switch comprising a screen module, a mount and a wall module according to the present disclosure;

FIGS. 2a and 2b show an embodiment of a screen module according to the present disclosure;

FIGS. 3a and 3b show an embodiment of a wall module according to the present disclosure; and

FIG. 4 shows an embodiment of a mount according to the present disclosure.

### DETAILED DESCRIPTION

A smart light switch 100 according to the present disclosure can be installed in a two-wire lighting circuit. In such a lighting circuit, the smart light switch 100 of the present disclosure solves the problem of allowing high-power components to be used when the lighting circuit is switched to an off state, without causing the lights in the lighting circuit to produce visible illumination.

In the present disclosure, the terms “on state” and “off state” are used to describe the state of a lighting circuit to which a smart switch 100 is electrically connected. “On state” means the power flowing through the lighting circuit is above a threshold level, such that light fittings connected to the lighting circuit produce visible illumination. This may, for example, mean that the full power of the lighting circuit is available to the lighting fittings, or that the power is provided at a reduced level in order to provide a lower level of illumination, while still being above the threshold level. This may be, for example, in response to the smart light switch 100 providing a dimming function. “Off state” typically does not mean that no power is flowing through the circuit. Instead, in the context of the present disclosure, the term “off state” means that the power flowing through the lighting circuit is below a threshold level. The threshold level may be determined as a level that prevents connected light fittings from producing visible illumination.

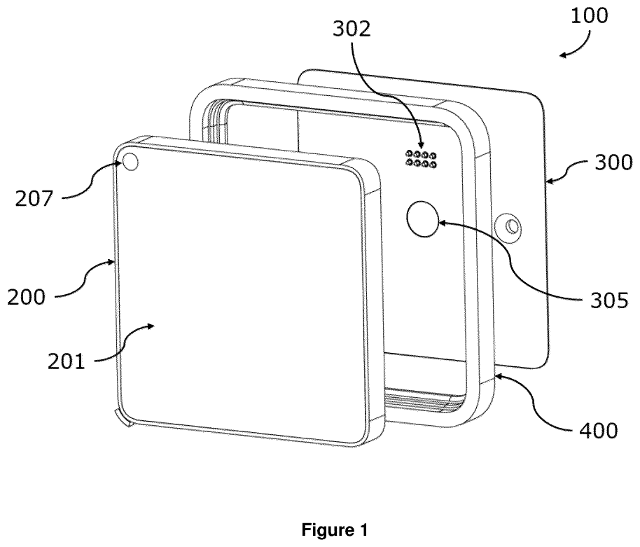

FIG. 1 shows a schematic representation of a smart light switch 100 according to an embodiment of the present disclosure. The smart light switch 100 illustrated in FIG. 1 has a screen module 200, a wall module 300 and a mount 400. Each of these components are described in more detail below, in relation to this and other figures.

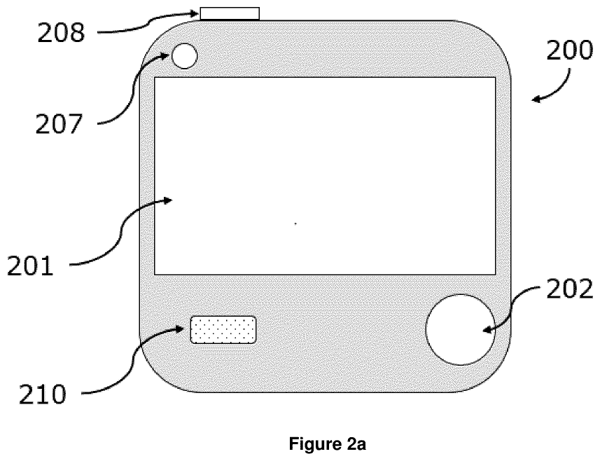

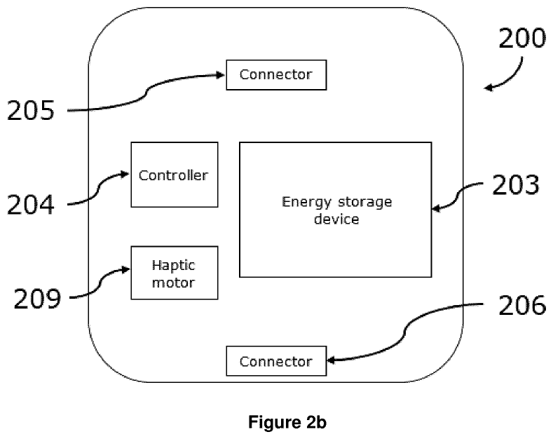

FIGS. 2a and 2b show a schematic representation of a screen module 200 according to an embodiment of the present disclosure. The screen module 200 comprises a display 201, and an input device 202. The display 201 may use any form of suitable display technology such as LCD or OLED and is preferably an AMOLED screen. In the example illustrated in FIG. 2a, the input device is in the form of a dial and/or a button. Any form of suitable input device 202 may be used. In a preferred example, the display 201 and the input device 202 are combined into a touchscreen, such as an AMOLED touch screen. An example of such a combined display 201 and input device 202 is illustrated in FIG. 1, in which an AMOLED touch screen is used. The display 201 shows a user interface that can be interacted with using the input device 202. The user interface is configured to provide user access to the functionality of the smart light switch 100. The user interface is further configured to display information to a user. Such information may comprise, for example, information determined by one or more sensors (as discussed in more detail below). Some elements of the user interface may be user configurable. A user may be able to configure the user interface using the input device 202. A user may additionally, or alternatively, configure the user interface using a separate device such as a smart phone or computer.

The screen module 200 comprises an energy storage device 203. The energy storage device 203 is configured to store electrical energy to provide power for the screen module 200. The energy storage device 203 is rechargeable and is configured to be chargeable using energy provided by the wall module when the screen module 200 is operatively connected to the wall module 300. The energy storage device 203 may be any suitable device, such as a battery or a capacitor.

The screen module 200 comprises a first screen module connector 205, which is configured to operably connect with a wall module 300. The first screen module connector 205 is configured to receive electrical power from an operably connected wall module 300. The first screen module connector 205 may also be configured to form a data connection with an operably connected wall module 300, through which data may be exchanged with the wall module. Data exchanged with the wall module 300 may include instructions to switch an attached lighting circuit between an on state and an off state. Alternatively, the screen module 200 may comprise an additional separate screen module connector (not shown) to form a data connection with a wall module 300.

In a preferred example, the first screen module connector 205 comprises disc connectors that are configured to be operatively connectable to corresponding spring loaded pogo-pins that comprise the first wall module connector 302. In a preferred example, the first screen module connector 205 comprises eight disc-type connectors arranged in a 2×4 grid pattern and the first wall module connector 302 comprises eight spring loaded pogo-pins arranged in a corresponding 2×4 grid pattern.

The screen module 200 comprises a screen module controller 204, configured to control the functionality of the screen module 200. The screen module controller 204 may be a hardware controller or may be a computer processor configured to execute instructions stored in an operatively attached computer memory (not shown). The screen module controller 204 is also configured to control the power management of the screen module 200. In some examples, the screen module controller 204 may comprise multiple controllers, each controller being configured to manage one or more of the functions of the screen module 200. For example, in one example the electrical power management of the screen module is controlled by a power management controller (not shown), while other functions of the screen module are controlled by a separate controller. In such examples, the various controllers are collectively referred to as the screen module controller 204.

The screen module controller 204 is configured to determine if electrical power is being supplied by an operatively connected wall module 300. The screen module controller 204 is also configured to determine an upper limit to the amount of power that can be supplied to the screen module 200 by an operatively connected wall module 300. In an example, this limit may be determined by attempting to draw power from the wall module until an upper limit is reached. In another example, the set upper limit may be communicated to the screen module 200 from the wall module 300. If the upper limit is above a threshold amount, the screen module controller 204 configures the screen module to operate the screen module using the electrical power supplied by the wall module 300. If the upper limit is below the threshold amount, the screen module controller 204 configures the screen module to operate using electrical power drawn from the energy storage device 203. The threshold amount may be predetermined or may be definable by the user. In an example, the threshold amount may be an amount of power needed to operate a subset of the components of the screen module 200 at full functionality. For example, the threshold amount may be an amount needed to operate the display at full brightness, while also operating other required components.

The screen module controller 204 is configured to determine the charge state of the energy storage device 204. The charge state may be determined by any suitable method, for example by measuring the voltage of the energy storage device 204. If the energy storage device 204 is determined to be less than fully charged, and if electrical power is being supplied to the screen module 200 by an operatively connected wall module 300, the screen module controller 204 may configure the screen module 200 such that a portion of the supplied power is used to recharge the energy storage device 204. In some examples, the energy storage device 204 may only be charged if the upper limit of the supplied electrical power exceeds the usage requirements of the other components of the screen module 200.

The screen module controller 204 is configured to detect when the screen module 200 is in use by a user. This may be determined, for example, by a recent interaction with the input device 202. If the screen module controller 204 determines that the screen module 200 is not in use, the screen module controller 204 may switch the screen module 200 into a power save mode. The power save mode may, for example, involve disabling high-power components such as the display 201. The screen module controller 204 may be configured to switch the screen module 200 into a power save mode more quickly when it is determined that the amount of power being supplied to the screen module 200 is below the threshold amount described above (which usually means the lighting circuit is in an off state, or that the screen module is detached from the wall module 300).

If the screen module 200 is in a power save mode, and the screen module controller 204 detects the screen module 200 is in use by a user, the screen module controller 204 may switch the screen module into a normal power mode. The normal power mode may, for example, involve enabling all components for normal usage.

By switching the screen module 200 to a power save mode when not in use, the device is able to minimise wasted energy. Switching to a power save mode when not in use allows for the energy storage device 203 to power the screen module 200 for a long period of time without charging.

In an example where the screen module 200 is operably connected to the wall module 300, and the attached lighting circuit is in an off state, electrical power will be supplied to the screen module 200 but at a level below the threshold amount. By switching to a power save mode when not in use, the amount of power being used by the screen module 200 is minimised, and so as much power as possible is used to recharge the energy storage device 203. This allows for sufficient charge to be maintained in the energy storage device 203 in to allow for a normal power mode to be employed during normal usage patterns, even if the lighting circuit is not switched to an on state for an extended period of time.

The screen module controller 204 is configured to identify when the charge state of the energy storage device 203 drops below a threshold charge level. If the charge state of the energy storage device 203 is determined to have dropped below a threshold charge level, and the controller determines that the amount of power being supplied to the screen module 200 is below the threshold amount described above, the controller may configure the screen module 200 to operate in a low power mode. The functionality of the screen module when in low power mode may be predetermined or may be user configurable. The low power mode may cause certain high power consumption components, such as the display, to operate in a reduced power mode. In some examples, if the charge level of the energy storage device 203 drops below a critical level, the screen module controller 204 may configure the screen module to operate in a sleep mode. The sleep mode may, for example, configure the screen module 200 to operate using a minimal amount of power. This may involve, for example, disabling high power consumption components such as the display. When in a sleep mode, the screen module 200 may, for example, be configured such that the only functionality maintained is the ability to switch lights on and off using the input device 202. The screen module controller 204 may be configured to warn the user (for example by visual, audible and or haptic feedback) before entering a low power or sleep mode.

In an example where the screen module 200 is operably connected to the wall module 300, and the screen module controller 204 identifies that the charge state of the energy storage device 203 has drops below a threshold level, the screen module controller 204 may be configured to switch a connected lighting circuit from an off state to an on state. By switching the lighting circuit to an on state, the screen module 200 will be supplied with at least the threshold amount of electrical power, thereby allowing the screen module 200 to function and to charge the energy storage device 203. This allows for the screen module controller 204 to avoid a situation where insufficient electrical power is available to operate the screen module 200 (from both an operably connected wall module 300 and from the energy storage device 203), which would otherwise cause the screen module 200 to become inoperable. In some examples, the screen module controller 204 may be configured to switch the connected lighting circuit to an off state once the energy storage device 203 reaches a second threshold charge level. In some examples, this functionality may be user configurable. The user may be able to configure the threshold charge level of the energy storage device 203 at which the screen module controller 204 switches the lighting circuit to an on state and/or the second threshold charge level at which the screen module controller 204 switches the lighting circuit to an off state. The user may also be able to configure the screen module 200 such that automatic switching of the lighting circuit by the screen module controller 204 is disabled.

The screen module 200 may further comprise means for providing haptic feedback to a user. For example, the screen module may comprise a haptic motor 209 configured to provide haptic feedback, such as vibration when elements of the user interface are interacted with by the user.

The screen module 200 may further comprise one or more sensors. In the examples illustrated in FIGS. 1 and 2a, the screen module comprises a camera 207. The camera 207 may be a visible spectrum camera. Alternatively, or additionally, the camera 207 may be an infra-red camera. Cameras using the visible or infra-red spectrum provide different information. An infra-red camera may be able to detect the presence of human beings and/or pets by identifying thermal emissions produced by warm bodies. In an example, identifying a warm body and determining that said warm body is in motion may allow the screen module to identify the presence of a human and/or pet, the motion aspect differentiating the person and/or pet from immobile heat sources such as a radiator. Using infra-red emissions in this manner may be preferable to using a visible spectrum camera for identifying the presence of people and/or pets, since visible spectrum cameras may need to employ more sophisticated image recognition software to allow for people and/or pets to be identified. In some examples a visible spectrum camera may be used for facial recognition in order to identify a particular user. A visible spectrum camera may also be used for security purposes, to provide a live video feed for monitoring, or to record a video feed for later review.

The one or more sensors may also comprise an air quality sensor or a temperature sensor. The air quality sensor may be able to determine a range of atmospheric properties such as humidity and pressure. The air quality sensor may also be able to detect the presence of unwanted or dangerous contaminants in the air, such as carbon monoxide, particulate smoke, NO₂, radon or natural gas. The sensors may be used to provide information shown in the user interface, may be supplied to an external device or may be used to activate alarms (for example, if unsafe quantities of an atmospheric pollutant are detected).

The one or more sensors may also comprise a microphone 210. The microphone 210 may allow a user to issue voice commands to the screen module 200. The microphone 210 may also act as a security feature, allowing for recording and/or live monitoring of the environment around the smart switch. In an example, the microphone 210 could allow for the screen module to be used as a baby monitor.

The screen module 200 may further comprise a privacy switch 208 configured to disable one or more of the sensors. For example, in a screen module 200 comprising a camera 207, the privacy switch may disable the camera 207. In an example of a screen module 200 comprising a camera 207, the privacy switch may be configured such that when activated it physically covers the of the camera 207. The physical cover of the privacy switch 208 may be visible to the user. This is beneficial as it provides the user with easily verifiable proof that the camera is unable to capture any image data, which may be desirable in circumstances where personal privacy is needed. In another example, the privacy switch 208 physically separates the power connection to the camera 207, thereby preventing the camera 207 from functioning. In this example, the physical position of the privacy switch 208 may indicate to the user if the camera 207 is disabled.

In an example where the screen module comprises a camera 207 and a microphone 210, the privacy switch 208 may be configured to selectively disable either the camera 207, the microphone 210 or both components. In a preferred example, the privacy switch 208 is configured to have three switchable positions: in the first position, the camera 207 and the microphone 210 are both active; in the second position, the camera 207 is disabled but the microphone 210 is active; in the third position, the camera 207 and the microphone 210 are both disabled.

The screen module 200 may further comprise a speaker (not shown in the figures). The speaker could allow for the screen module 200 to provide audible feedback to the user. The speaker could also allow for music to be played through the screen module 200.

The screen module 200 may further comprise a wireless communication controller, configured to provide the screen module with wireless communication capabilities. The wireless communication controller may use any suitable wireless communication technology, such as Wi-Fi, Bluetooth, Bluetooth LE, Zigbee, Thread. The wireless communication controller may allow the screen module to form a wireless data connection to other components of the smart light switch 100, such as a wall module 300 and a mount 400. A wireless connection formed between the screen module 200 and a wall module 300 may allow for the screen module 200 to instruct the wall module 300 to switch an attached lighting circuit between an on state and an off state, even when the screen module 200 is detached from the wall module 300.

In some examples, the wireless communication controller may allow the screen module 200 to act as a Wi-Fi access point. The Wi-Fi access point may be part of a wireless mesh network formed with other Wi-Fi access points. In an example, internet connectivity may be provided via the mesh network. In another example, internet connectivity may be provided via a data connection to the wall module 300.

The screen module 200 may comprise additional screen module connectors, configured to connect to other devices and/or components. For example, a second screen module connector 206 may be configured to be operably connected to a mount 400. This may allow for the screen module 200 to gain additional functionality, or to provide another device/component with additional functionality.

The screen module 200 is configured to be removably attachable to a wall module 300. When attached to the wall module 300, the screen module 200 may be retained in place by any suitable means, including clips, magnets and/or an interference fit. Preferably, the screen module 200 and wall module 300 are configured such that when the screen module 200 is attached to the wall module 300, the first screen module connector 205 is operably connected to the first wall module connector 302.

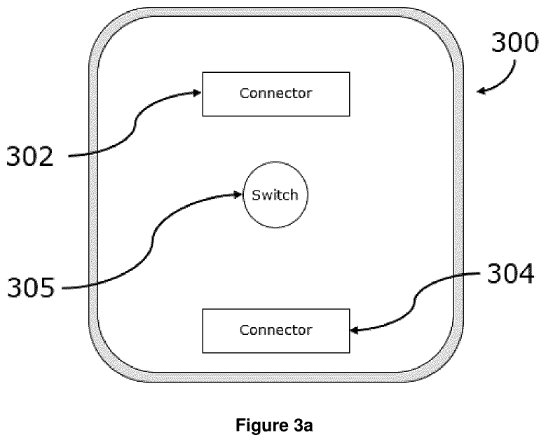

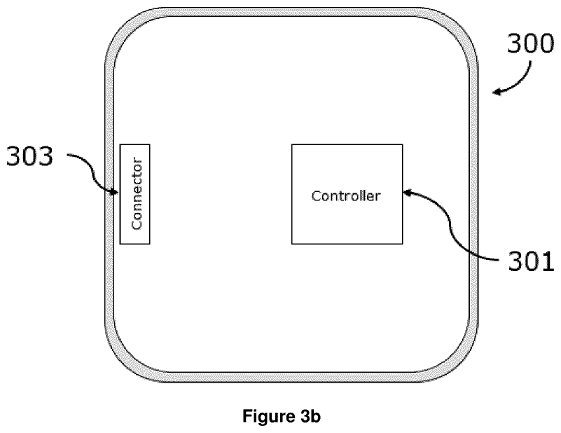

FIGS. 3a and 3b show a schematic representation of a wall module 300 according to an embodiment of the present disclosure. The wall module 300 comprises a wall module controller 301, configured to control the operation of the wall module 300. The wall module 300 also comprises a first wall module connector 302, configured to be operably connected to a first screen connector 205 of a screen module 200. The first wall module connector 302 is configured to provide electrical power to an operably connected screen module 200. In some examples, the first wall module connector 302 may be configured to additionally form a data connection with an operably connected first screen connector 205 of a screen module 200. The data connection may be used, for example, to pass switching instructions from the screen module 200 to the wall module 300 when the screen module 200 is operably connected to the wall module 300. As discussed above, in a preferable example the first wall module connector 302 comprises eight spring loaded pogo-pins arranged in a 2×4 grid pattern, as illustrated in FIG. 1.

The wall module 300 also comprises a first electrical connector 303, configured to be connected to the electrical wiring of a lighting circuit. The first electrical connector 303 is configured to be connectable to a two-wire and/or a three-wire lighting circuit. The first electrical connector 303 may be configured to be connectable to other types of lighting circuits. In some examples, the wall module 300 may comprise additional electrical connectors (not shown) in order to connect to additional lighting circuits. In examples where the wall module 300 comprises multiple electrical connectors, each connected to a separate lighting circuit, the smart light switch 100 is able to control each lighting circuit independently.

The wall module controller 301 is configured to manage the electrical power usage and distribution within the wall module 300. The wall module controller 301 is further configured to determine if the attached lighting circuit is in an on state or an off state, and to switch the attached lighting circuit between an on state and an off state. The state of the lighting circuit may be controlled by the wall module controller 301, or by another smart light switch 100.

The wall module controller 301 may also be configured to monitor and record the instantaneous current and voltage levels in an attached lighting circuit. The measured information may be stored within the wall module 300, or may be transmitted to the screen module 200. The recorded information may be provided to a user and/or may be transmitted to a remote server for data analysis.

The wall module controller 301 is configured to limit the amount of electrical power drawn from an attached lighting circuit, when the attached lighting circuit is in the off state, to below a threshold amount. The threshold amount is configured such that when power is drawn below the threshold amount, lights attached to the lighting circuit do not produce visible illumination. The threshold amount may be pre-set, or may be user configurable. User configurability may be beneficial, as depending on the type and number of attached lights, a greater or lower threshold amount may be required in order to allow for as much power to be drawn as possible without causing visible illumination.

In an example, the wall module controller 301 may be configured to be able to perform a calibration process. The calibration process may be used to determine the threshold amount of power that can be drawn from an attached lighting circuit. In an example of a calibration process, a progressively larger amount of power is drawn from an attached lighting circuit in order to determine the maximum amount that can be drawn without lights attached to the lighting circuit producing visible illumination. In some examples, the wall module controller 301 may be configured to automatically determine whether visible light is being emitted, for example by using one or more attached cameras. In another example, an external device (such as a smartphone) may be used in order to determine whether visible light is being emitted. In a further example, user input may be required in order to indicate if visible light is being emitted. In such examples, the calibration process may allow for the determination of a threshold amount of power that can be drawn from an attached lighting circuit, without lights attached to the lighting circuit producing visible illumination.

In some examples, the threshold amount may be approximately 10% of the total load of the lighting circuit when the lighting circuit is in an on state, and in a preferred example the threshold amount may be 12%.

The wall module controller 301 is configured to supply as much power as possible to the first wall module connector 302, while also providing power to the wall module components (such as the wall module controller 301). This in turn provides as much power as possible to an operably connected screen module 200. This means that when an attached lighting circuit is in an on state, the wall module 300 provides power above the threshold level to an operably connected screen module 200. This also means that when the attached lighting circuit (or all of the attached lighting circuits, if multiple lighting circuits are connected) is in an off state, the wall module 300 provides power below the threshold amount to an operably connected screen module 200.

The wall module 300 may also comprise a switch 305, configured to allow a user to switch an attached lighting circuit between an on and an off state. The switch 305 allows the user to switch an attached lighting circuit between an on and an off state, even if the screen module is detached from the smart light switch 100. In an example, the switch 305 is a button, and the actuation of the switch 305 is registered by the microcontroller which then actuates one or more dimming circuits, to switch an attached lighting circuit between an on and an off state. This may be beneficial if, for example, the screen module 200 has been removed, or if the energy storage device 203 of the screen module is fully depleted. This is also beneficial, as it allows for the lighting circuit electrical connection to be more easily tested when installing the smart light switch, as the screen module 200 is not needed to switch an attached lighting circuit between an on and an off state.

The wall module 300 may comprise additional wall module connectors. For example, a second wall module connector 304 may be configured to be operably connectable to a mount 400.

The wall module 300 may also be configured to be connectable to a wired network connection, for example an ethernet connection. This may provide the wall module 300 with a fast network and/or internet connection. This may allow for an operably connected screen module 200 and/or mount 400 to make use of the fast network connection. In an example, the wired network connection could be used in order to allow the smart switch 100 to act as a Wi-Fi access point. The Wi-Fi access point may be provided by the wall module 300, or by an operably connected screen module 200 and/or mount 400.

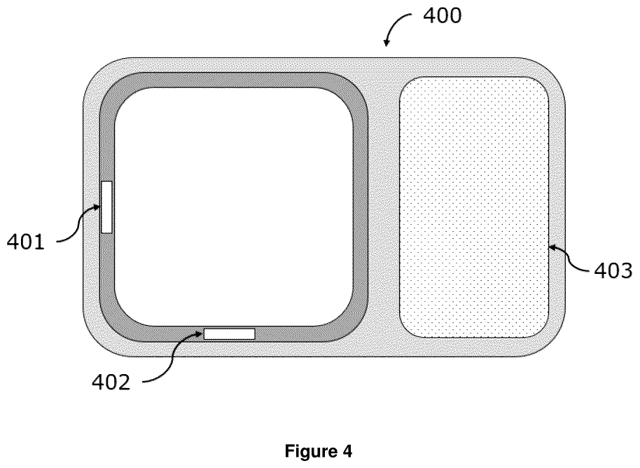

FIG. 4 shows a schematic representation of a mount 400 according to an embodiment of the present disclosure. A mount 400 according to the present disclosure is an additional component that may be located between the wall module 300 of a smart light switch 100 and the wall on which it is mounted. A smart light switch 100 comprising a screen module 200, a wall module 300 and a mount 400 is illustrated in FIG. 1.

The mount 400 is configured to be removably attachable to a wall module 300 and/or a screen module 200. When attached, the mount 400 may be retained in place by any suitable means, including clips, magnets and/or an interference fit.

In a preferred example, the mount 400 is configured to be installed with a portion of the mount located between a portion of the wall module 300 and a wall, such that when the wall module 300 is attached to the wall, the portion of the mount 400 is compressed between the wall module 300 and the wall, thereby securing the mount 400 in place. In this preferred example, the screen module 200 is configured to be removably attached to the wall module 300, such that when the screen module 200 is attached to the wall module 300, the first screen module connector 204 is operably connected to the first wall module connector 302.

In a further example, the first mount connector 401 and the second wall module connector 304 may be arranged such that following installation, an operable connection between these connectors is formed in the portion of the mount that is compressed between the wall module and the wall, thereby providing a secure and concealed connection. Such an arrangement of connectors may improve the physical stability of the operable connection between the mount 400 and the wall module 300, while also improving the aesthetics of the smart light switch 100 by concealing the connection.

The mount 400 may be provided in a range of sizes and colours according to user preference. A mount 400 may improve the aesthetics of the smart light switch 100, by allowing the user to easily customise the appearance of the smart light switch 100. A mount 400 may also make installation of the smart light switch 100 easier by providing a simple method for concealing any damage that may be caused to the wall area immediately surrounding the light switch during installation.

The mount 400 may also be configured to provide additional functionality. In one example, the mount may be configured to include one or more mount connectors (401, 402) each configured to operably connect to another component of the smart light switch 100 and/or to another device. For example, the first mount connector 401 may be configured to operably connect to a wall module 300. This connection may provide the mount with electrical power and may additionally provide the mount with a data connection to the wall module.

The mount 400 may further comprise a wireless communication controller, configured to provide the mount with wireless communication capabilities. The wireless communication controller may use any suitable wireless communication technology, such as Wi-Fi, Bluetooth, Bluetooth LE, Zigbee. The wireless communication controller may allow the mount 400 to form a wireless data connection to other components of the smart light switch 100, such as the wall module 300 and the screen module 400. In some examples, the wireless communication controller may allow the mount 400 to act as a Wi-Fi access point. The Wi-Fi access point may be part of a wireless mesh network formed with other Wi-Fi access points. In an example, internet connectivity may be provided via the mesh network. In another example, internet connectivity may be provided via a data connection to the wall module 300.

The mount 400 may further comprise a speaker 403, a microphone and/or one or more sensors. The functionality of each of these features is similar to the functionality of the corresponding features discussed above in relation to the screen module 200.

As discussed above, any of the components of the smart light switch 100 may comprise means for connecting to a network. In order to function as a smart light switch 100, at least one component must be able to connect to a network. Preferably, the screen module 200 is connectable to a network and is connected to a network during use. The network may be any suitable form of network, but is preferably a Wi-Fi network. When connected to a network, the screen module 200 may be controllable via an external device. The device may be a smart phone or other computing device (tablet, computer, smart watch etc.) that is also connected to the network. Alternatively, or additionally, the smart light switch 100 may be connected to the internet, in order to allow the smart light switch to be controlled by a user remotely. This may be beneficial if, for example, a user who is away from their home wishes to make use of any of the smart switch functionality, such as monitoring for intruders using an attached camera. An internet connection may also be used in order to connect with cloud services, for purposes such as backing up data, obtaining software updates and providing analytic data.

The smart light switch 100 may also be connectable to other smart devices, such as other smart light switches, plug sockets or home hubs.

The smart light switch 100 may be configurable to operate in a standard mode or in a full power mode. When operating in the standard mode, the smart light switch 100 limits the amount of power drawn from the lighting circuit when it is in an off state to below a threshold, thereby preventing lights in the lighting circuit from producing visible illumination, as described in more detail above. When operating in full power mode, the smart light switch does not limit the power drawn to below the threshold, even when the lighting circuit is in an off state. The full power mode may only be usable if the smart light switch 100 is installed in a lighting circuit that includes a neutral wire, otherwise known as a three-wire lighting circuit. When installed in a three-wire circuit, the smart light switch 100 can use the neutral wire to allow power draw from the lighting circuit above the threshold amount while the lighting circuit is in an off state, without causing the lights in the lighting circuit to produce visible illumination.

In some examples, the smart light switch 100 may be switchable between operating in a standard mode and a full power mode. The smart light switch 100 may comprise a mode switch configured to switch the operating mode between a standard mode and a full power mode. The mode switch may be disposed on the wall module 300, the screen module 200 and/or the mount 400. The mode switch may be a physical switch, and/or may be an option displayed on the screen of the screen module 200. In some examples, the mode switch may be operable by verbal command. In examples where the smart light switch 100 comprises wireless communication capabilities, the operating mode may be remotely controllable, for example via an app operating on another device. In some examples, the operating mode may be automatically switchable, with the smart light switch 100 (or a component thereof) determining that the full power mode can be activated without causing the lights in the lighting circuit to produce visible illumination when the lighting circuit is in an off state, for example by detecting that a neutral wire has been connected.

1. A screen module for use in a smart light switch, the screen module comprising:
a display;
an input device;
an energy storage device;
a screen module controller; and
a first screen module connector configured to be operably connected with a wall module, wherein the connector is configured to supply electrical power to the screen module from the wall module;
wherein the screen module controller is operable to:
determine the charge state of the energy storage device; and
if electrical power is supplied to the first screen module connector and the determined charge state of the energy storage device indicates that the energy storage device is not fully charged, configure the screen module to use at least a portion of the supplied electrical power to charge to the energy storage device;
and wherein the screen module controller is further operable to:
determine if the limit of the amount of electrical power being supplied to the screen module via the first screen module connector is at or above a threshold amount;
if the limit is determined to be at or above the threshold amount, configure the screen module to be powered by the electrical power supplied via the first screen module connector; and
if the limit is determined to be below the threshold amount, configure the screen module to be powered by the energy storage device.

2. The screen module according to claim 1, wherein the input device is a touch screen.

3. The screen module according to claim 1, further comprising a haptic motor configured to give haptic feedback.

4. The screen module according to claim 1, further comprising at least one sensor selected from a group comprising: an air quality sensor, a temperature sensor, an infrared camera, a visible spectrum camera, a microphone.

5. The screen module according to claim 4, further comprising a privacy switch configured to selectively disable one or more of the sensors.

6. The screen module according to claim 1, further comprising a speaker.

7. The screen module according to claim 1, further comprising a wireless communication controller configured to provide the screen module with wireless communication capability.

8. The screen module according to claim 1, further comprising a second screen module connector configured to be operably connected with a mount.

9. A wall module for use in a smart light switch, the wall module comprising:
a wall module controller;
a first wall module connector configured to be operably connected to a screen module, wherein the connector is configured to supply electrical power to the screen module from the wall module; and
a first electrical connector configured to be operably connected to the electrical wiring of a lighting circuit;
wherein the wall module controller is operable to:
selectively switch the connected lighting circuit between an on state and an off state;
determine if a connected lighting circuit is in an on state or an off state; and
if the connected lighting circuit is determined to be in an off state, configure the wall module to limit the supply electrical power to the first wall module connector to below a threshold amount; or
if the connected lighting circuit is determined to be in an on state, configure the wall module to allow for the supply electrical power to the first wall module connector to equal or exceed the threshold amount.

10. The wall module according to claim 9, wherein the threshold amount is the maximum amount of electrical power that can be drawn from a connected lighting circuit, without causing any lights of the connected lighting circuit to produce visible light.

11. The wall module according to claim 10, wherein the wall module controller is further configured such that, when connected to a lighting circuit, the wall module controller is able to determine the threshold amount.

12. The wall module according to claim 9, further comprising at least one switch configured to allow a user to change the on/off state of a connected lighting circuit.

13. The wall module according to claim 9, further comprising at least one additional electrical connector.

14. The wall module according to claim 13, wherein each of the at least one additional connectors are configured to be operably connected to a separate lighting circuit.

15. The wall module according to claim 9, further comprising a second wall module connector configured to be operably connected to a mount.

16. The wall module according to claim 9, further comprising a wireless communication controller configured to provide the wall module with wireless communication capability.

17. A smart light switch comprising a screen module according to claim 1 and a wall module according to claim 9.

18. The smart light switch according to claim 17, further comprising a mount.

19. The smart light switch according to claim 18, wherein the mount is operably connected to at least one of the screen module and the wall module.

20. The smart light switch according to claim 19, wherein the mount further comprises at least one of: a speaker, a display, an air quality sensor, a temperature sensor, an infrared camera, a visible spectrum camera, a microphone, a wireless communication controller configured to provide the mount with wireless communication capability, an energy storage device, an input device.

21. The smart light switch according to claim 17, further configured to be switchable between:
a first operating mode wherein the wall module limits the supply electrical power to the first wall module connector to below a threshold amount if the connected lighting circuit is determined to be in an off state; and
a second operating mode wherein the wall module does not limit the supply electrical power to the first wall module connector to below the threshold amount.

22. The smart light switch according to claim 21, further comprising a switch configured to switch the operating mode between a first operating mode and a second operating mode.

23. The smart light switch according to claim 21, wherein when connected to a lighting circuit, the threshold amount is the maximum amount of electrical power that can be drawn from the connected lighting circuit, without causing any lights of the connected lighting circuit to produce visible light.
